(19) United States
(12) Patent Application Publication
(10) Pub. No.: US 2025/0028848 A1
(43) Pub. Date: Jan. 23, 2025

(54) METHODS AND APPARATUS FOR GENERATING AND MONITORING A SECURITY INFRASTRUCTURE

(71) Applicant: VMware LLC, Palo Alto, CA (US)

(72) Inventors: MANISH JAIN, Faridabad (IN); VISHAL GUPTA, Ludhiana (IN); SURESH BALLA, Visakapatnam (IN); PRASHANT RAJPAL SINGH, Pune (IN); VARUN JAIN, Pune (IN)

(21) Appl. No.: 18/378,168

(22) Filed: Oct. 10, 2023

(30) Foreign Application Priority Data
Jul. 21, 2023 (IN) 20234104932

(51) Int. Cl. G06F 21/62

(52) U.S. Cl. CPC G06F 21/6218

(57) ABSTRACT

Systems, apparatus, articles of manufacture, and methods are disclosed to generate and monitor security infrastructure. An example apparatus comprises programmable circuitry to at least one of instantiate or execute the machine readable instructions to: provision the security infrastructure based on a security infrastructure generation request; detect a global infrastructure template based on the security infrastructure generation request; and generate the security infrastructure based on the provisioned security infrastructure, the global infrastructure template, and an identified security infrastructure generation authorization, the security infrastructure generation authorization to indicate whether the generation of the security infrastructure is permitted.

### RELATED APPLICATIONS

Benefit is claimed under 35 U.S.C. 119(a)-(d) to Foreign Application Serial No. 202341049432 filed in India entitled “METHODS AND APPARATUS FOR GENERATING AND MONITORING A SECURITY INFRASTRUCTURE”, on Jul. 21, 2023, by VMware, Inc., which is herein incorporated in its entirety by reference for all purposes.

### FIELD OF THE DISCLOSURE

This disclosure relates generally to management of cloud resources and, more particularly, to methods and apparatus for generating and monitoring a security infrastructure.

### BACKGROUND

Cloud computing is the delivery of computing resources including storage, processing power, databases, networking, analytics, artificial intelligence, and software applications via a networked data center. Cloud servers can include compute, memory, and/or storage resources to remotely perform services and functions for an organization. Cloud servers sometimes require a security infrastructure to prevent cyber-attacks and system-wide manipulations of data within the cloud computing system.

### BRIEF DESCRIPTION OF THE DRAWINGS

FIG. 1 is a schematic block diagram of an example environment in which an example security infrastructure generator operates to generate and monitor a security infrastructure.

FIG. 2 is a block diagram of the example security infrastructure generator of FIG. 1.

FIG. 3 is a block diagram of an example implementation of an example security infrastructure manager as shown in FIG. 2.

FIG. 4 is a flowchart representative of example machine readable instructions and/or example operations that may be executed, instantiated, and/or performed by example programmable circuitry to implement the security infrastructure manager of FIG. 3.

FIG. 5 is a flowchart representative of example machine readable instructions and/or example operations that may be executed, instantiated, and/or performed by example programmable circuitry to implement security infrastructure generation circuitry of FIG. 3.

FIG. 6 is a flowchart representative of example machine readable instructions and/or example operations that may be executed, instantiated, and/or performed by example programmable circuitry to implement security infrastructure monitoring circuitry of FIG. 3.

FIG. 7 is a block diagram of an example processing platform including programmable circuitry structured to execute, instantiate, and/or perform the example machine readable instructions and/or perform the example operations of FIGS. 4-6 to implement the security infrastructure generator of FIGS. 1-3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

### DETAILED DESCRIPTION

In cloud computing, organizations typically utilize security infrastructures to prevent loss of data, fraudulent attacks, and cyber threats. Cloud computing systems house and generate large amounts of potentially sensitive data and it is difficult to prioritize security alerts when a threat and/or unwanted activity is detected.

Security infrastructures are currently manually generated/configured by an engineer/administrator. Such a manual process is time-consuming and error prone due to human intervention and the expertise required to generate/configure such systems. In addition to the manual configuration of these security infrastructures, expertise and/or special training is required to debug/monitor such infrastructures to ensure they are operating properly and keeping the entire environment secure.

Examples disclosed herein provide a solution which automatically generates a security infrastructure (e.g., without user intervention) to avoid errors caused by human generation and reduce time. Additionally, examples disclosed herein provide a continuous monitoring system for monitoring the security infrastructure for malicious attacks and/or unwanted modifications without the need for expertise of the security infrastructure.

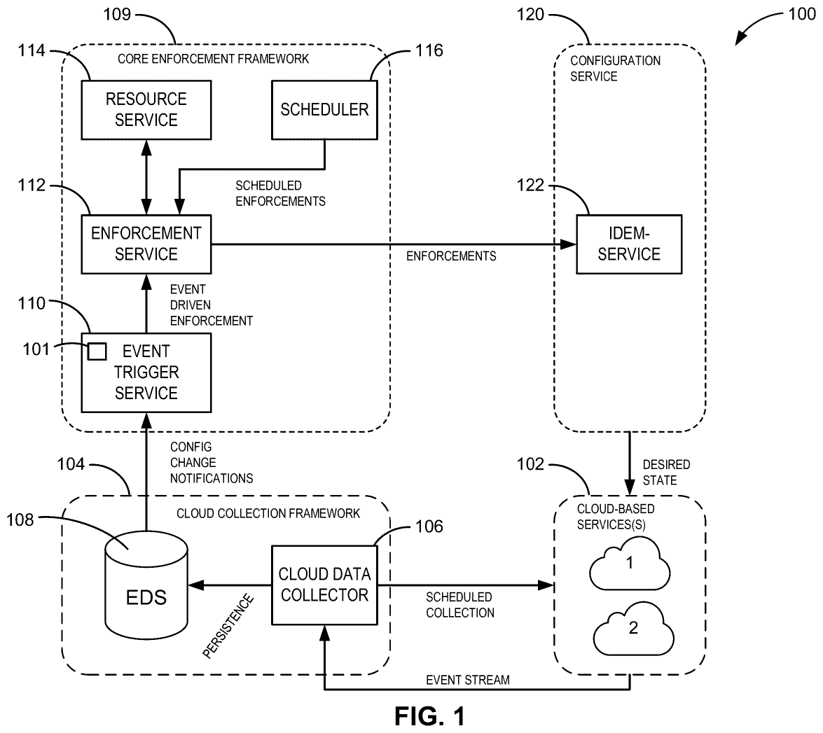

FIG. 1 is a schematic block diagram of an example environment 100 in which an example security infrastructure generator 101 that generates a security infrastructure can be implemented. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110 that implements the aforementioned security infrastructure generator 101, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud service(s) 122 based on enforcements provided from the enforcement service 112. While the security infrastructure generator 101 is shown implemented in the example event trigger service 110, additionally or alternatively, the security infrastructure generator 101 can be implemented in the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

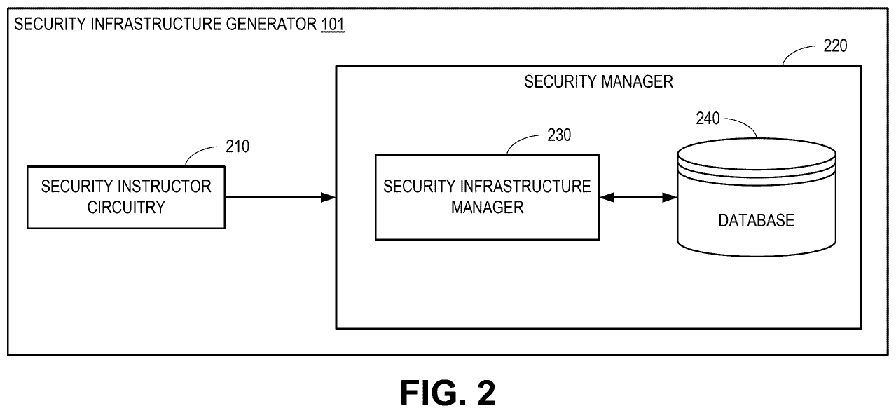

FIG. 2 is a block diagram of an example implementation of the example security infrastructure generator 101 of FIG. 1. The security infrastructure generator 101 of FIG. 2 includes security instructor circuitry 210 and a security manager 220. The security manager 220 includes a security infrastructure manager 230 and a database 240.

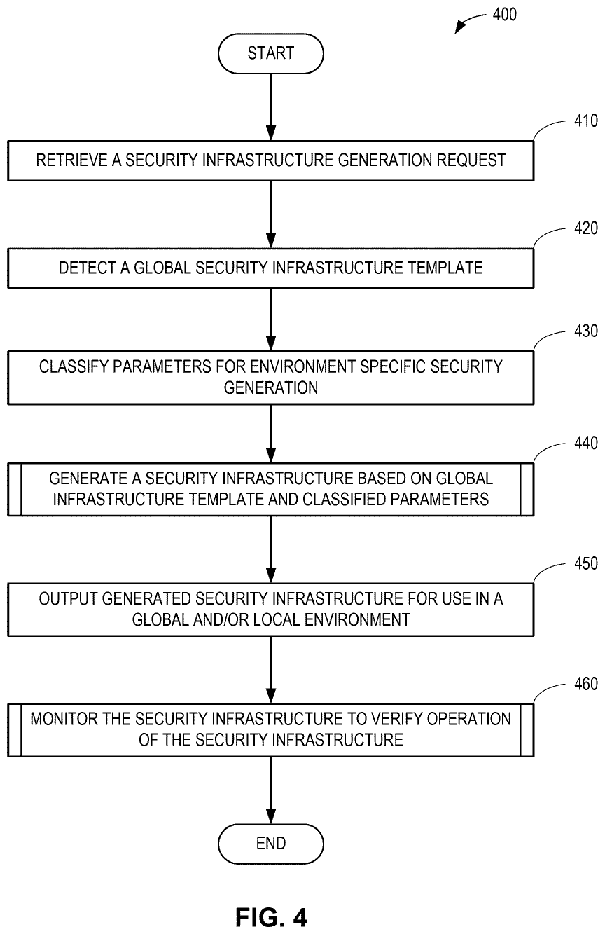

The security instructor circuitry 210 retrieves a security infrastructure generation request from the EDS 108 via the event trigger service 110. In some examples, the security instructor circuitry 210 is instantiated by programmable circuitry executing security instructor instructions and/or configured to perform operations such as those represented by the flowchart(s) of FIG. 4.

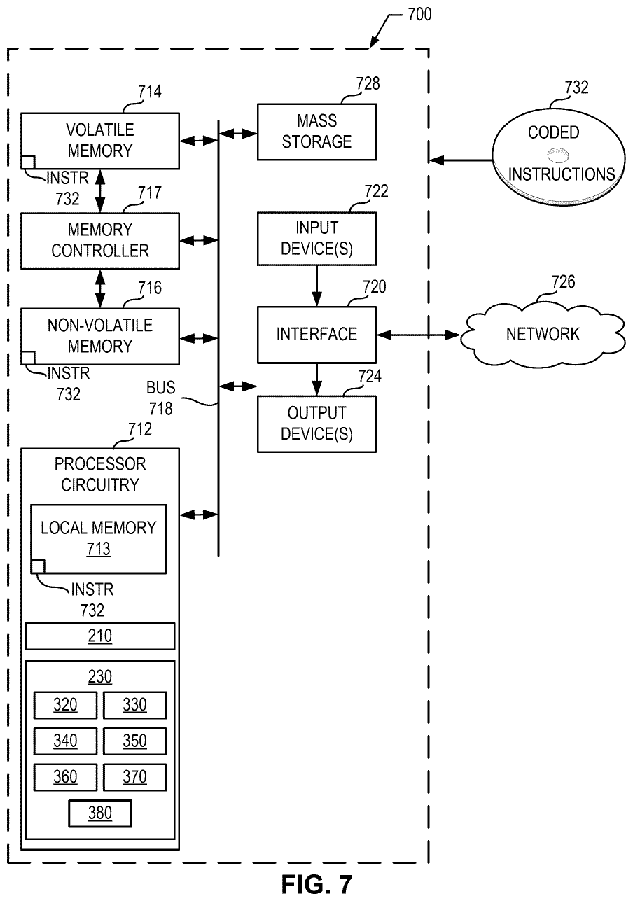

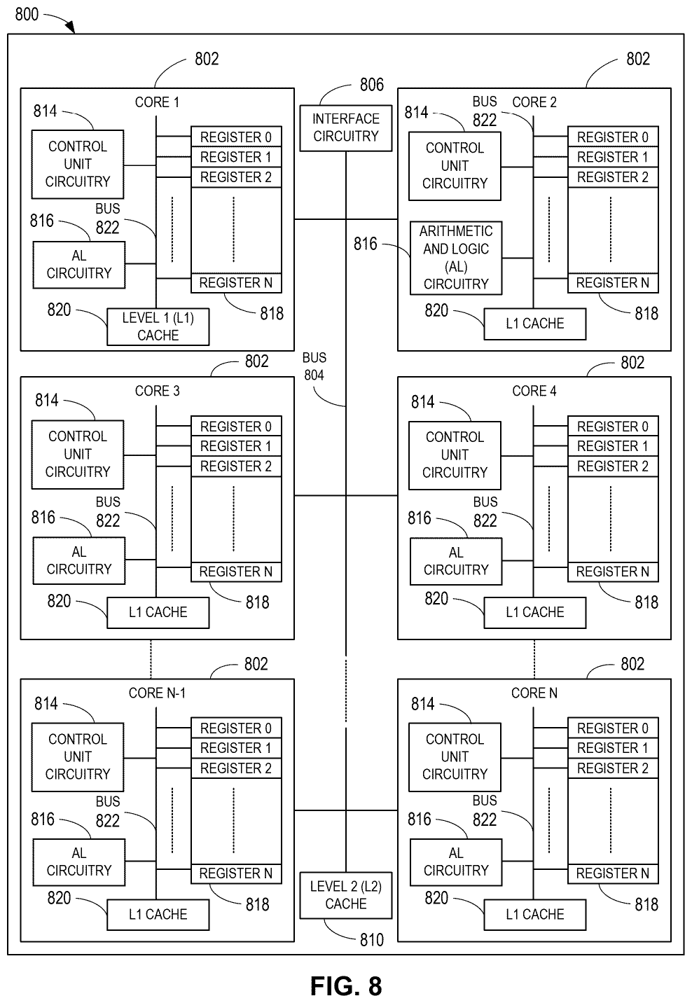

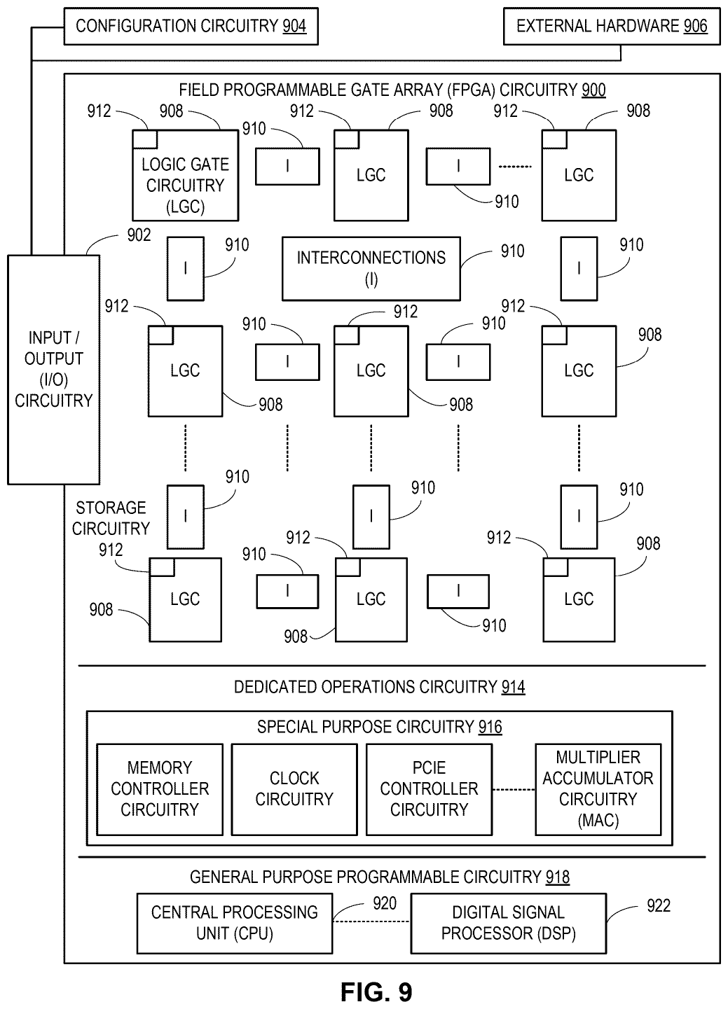

In some examples, the security infrastructure generator 101 includes means for retrieving a security infrastructure generation request. For example, the means for retrieving may be implemented by security instructor circuitry 210. In some examples, the security instructor circuitry 210 may be instantiated by programmable circuitry such as the example programmable circuitry 712 of FIG. 7. For instance, the security instructor circuitry 210 may be instantiated by the example microprocessor 800 of FIG. 8 executing machine executable instructions such as those implemented by at least block 410 of FIG. 4. In some examples, the security instructor circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security instructor circuitry 210 may be instantiated by any other combination of hardware, software, and/or firmware. For example, the security instructor circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security manager 220 manages the security of the environment 100. In some examples, the security manager 220 manages individual security policies for each computing device present in the environment 100. In some examples, the security manager 220 orchestrates management of a security infrastructure. The security infrastructure includes policies designed to block malicious attacks/cyber-attacks and to prevent unwanted and undesired policy changes. In such an example, policy changes by a user, either by accident or on purpose, can result in serious security risks (e.g., a file is accidentally deleted which contained a firewall/security policy to prevent read/write operations from unauthorized users. Such risks can pose just as much a threat to the environment 100 as a malicious actor engaging in a cyber-attack since the environment 100 is vulnerable to human error.

The security infrastructure manager 230 manages the security infrastructure for the security manager 220. In some examples, the managing of the security infrastructure includes both the generation of a security infrastructure and the monitoring of a security infrastructure during operation. In some examples, the security infrastructure manager 230 communicates with the database 240 to store and/or retrieve information from the database 240. The information can include previous and/or the current security infrastructure(s), reports on the operation of the security infrastructure, or any other information that may be valuable to determine whether the security infrastructure is operating properly.

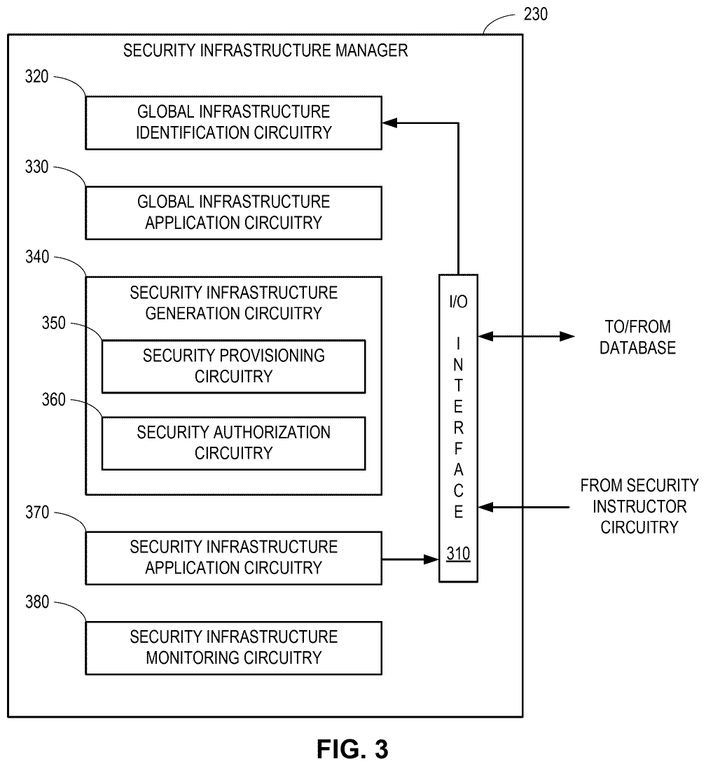

FIG. 3 is a block diagram of an example implementation of the security infrastructure manager 230 of FIG. 3 to generate and monitor a security infrastructure. The security infrastructure manager 230 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the security infrastructure manager 230 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The security infrastructure manager 230 includes an I/O interface 310, global infrastructure identification circuitry 320, global infrastructure application circuitry 330, security infrastructure generation circuitry 340, security provisioning circuitry 350, security authorization circuitry 360, security infrastructure application circuitry 370, and security infrastructure monitoring circuitry 380.

The global infrastructure identification circuitry 320 communicates with the I/O interface 310 to detect a global infrastructure template from the security instructor circuitry 210 and/or to communicate with the database 240. In some examples, the communication link with the security instructor circuitry 210 and/or the database 240 is a local network (e.g., Ethernet/wired communication). In other examples, the communication link is a virtual network (e.g., a Virtual Private Network (VPN), a cloud-based communication link, wireless communication such as Wi-Fi, etc.). In some examples, the global infrastructure identification circuitry 320 is instantiated by programmable circuitry executing global infrastructure identification instructions and/or configured to perform operations such as those represented by the flowchart(s) of FIG. 4.

In some examples, the security infrastructure manager 230 includes means for detecting a global infrastructure template. For example, the means for detecting may be implemented by global infrastructure identification circuitry 320. In some examples, the global infrastructure identification circuitry 320 may be instantiated by programmable circuitry such as the example programmable circuitry 712 of FIG. 7. For instance, the global infrastructure identification circuitry 320 may be instantiated by the example microprocessor 800 of FIG. 8 executing machine executable instructions such as those implemented by at least block 420 of FIG. 4. In some examples, the global infrastructure identification circuitry 320 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the global infrastructure identification circuitry 320 may be instantiated by any other combination of hardware, software, and/or firmware. For example, the global infrastructure identification circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The global infrastructure application circuitry 330 classifies parameters from the global infrastructure template to assist in the generation of the security infrastructure. In some examples, the global infrastructure application circuitry 330 is instantiated by programmable circuitry executing global infrastructure application instructions and/or configured to perform operations such as those represented by the flowchart(s) of FIG. 4.

In some examples, the security infrastructure manager 230 includes means for classifying parameters for application/environment specific security infrastructure generation. For example, the means for classifying may be implemented by global infrastructure application circuitry 330. In some examples, the global infrastructure application circuitry 330 may be instantiated by programmable circuitry such as the example programmable circuitry 712 of FIG. 7. For instance, the global infrastructure application circuitry 330 may be instantiated by the example microprocessor 800 of FIG. 8 executing machine executable instructions such as those implemented by at least block 430 of FIG. 4. In some examples, the global infrastructure application circuitry 330 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the global infrastructure application circuitry 330 may be instantiated by any other combination of hardware, software, and/or firmware. For example, the global infrastructure application circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security infrastructure generation circuitry 340 generates the security infrastructure. In some examples, the security infrastructure generation circuitry 340 is instantiated by programmable circuitry executing security infrastructure generation instructions and/or configured to perform operations such as those represented by the flowchart(s) of FIGS. 4 and/or 5.

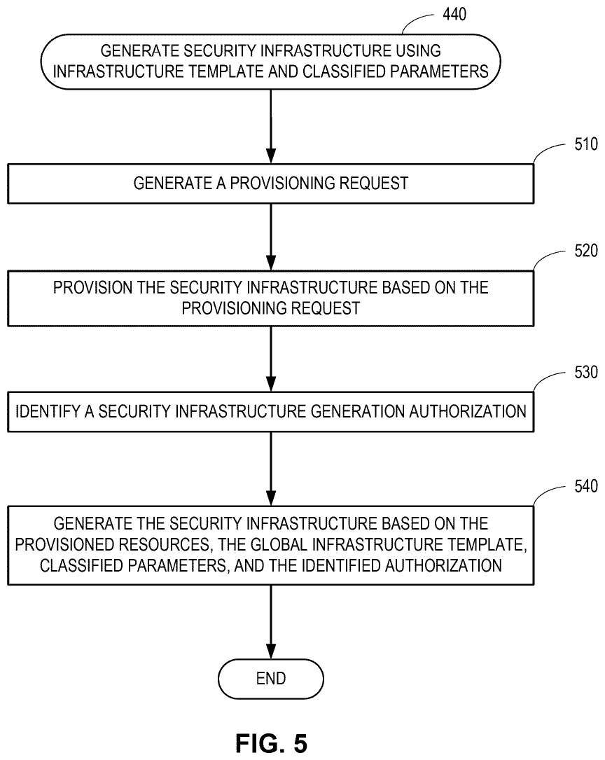

In some examples, the security infrastructure manager 230 includes means for generating a security infrastructure. For example, the means for generating may be implemented by security infrastructure generation circuitry 340. In some examples, the security infrastructure generation circuitry 340 may be instantiated by programmable circuitry such as the example programmable circuitry 712 of FIG. 7. For instance, the security infrastructure generation circuitry 340 may be instantiated by the example microprocessor 800 of FIG. 8 executing machine executable instructions such as those implemented by at least blocks 440 of FIG. 4 and 540 of FIG. 5. In some examples, the security infrastructure generation circuitry 340 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security infrastructure generation circuitry 340 may be instantiated by any other combination of hardware, software, and/or firmware. For example, the security infrastructure generation circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security provisioning circuitry 350 generates and provisions the security infrastructure based on the security infrastructure generation request. In some examples, the security provisioning circuitry 350 is instantiated by programmable circuitry executing security provisioning instructions and/or configured to perform operations such as those represented by the flowchart(s) of FIG. 5.

In some examples, the security infrastructure manager 230 includes means for provisioning the security request based on the security infrastructure generation request. For example, the means for provisioning may be implemented by security provisioning circuitry 350. In some examples, the security provisioning circuitry 350 may be instantiated by programmable circuitry such as the example programmable circuitry 712 of FIG. 7. For instance, the security provisioning circuitry 350 may be instantiated by the example microprocessor 800 of FIG. 8 executing machine executable instructions such as those implemented by at least blocks 510 and 520 of FIG. 5. In some examples, the security provisioning circuitry 350 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security provisioning circuitry 350 may be instantiated by any other combination of hardware, software, and/or firmware. For example, the security provisioning circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security authorization circuitry 360 identifies a security infrastructure generation authorization. In some examples, the security authorization circuitry 360 is instantiated by programmable circuitry executing security authorization instructions and/or configured to perform operations such as those represented by the flowchart(s) of FIG. 5.

In some examples, the security infrastructure manager 230 includes means for identifying a security infrastructure generation authorization. For example, the means for identifying may be implemented by security authorization circuitry 360. In some examples, the security authorization circuitry 360 may be instantiated by programmable circuitry such as the example programmable circuitry 712 of FIG. 7. For instance, the security authorization circuitry 360 may be instantiated by the example microprocessor 800 of FIG. 8 executing machine executable instructions such as those implemented by at least block 530 of FIG. 5. In some examples, the security authorization circuitry 360 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security authorization circuitry 360 may be instantiated by any other combination of hardware, software, and/or firmware. For example, the security authorization circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security infrastructure application circuitry 370 outputs the generated security infrastructure for global and/or local use. In some examples, the security infrastructure application circuitry 370 outputs the security infrastructure via the I/O interface 310 to communicate with the database 240. In some examples, the security infrastructure is stored on the database 240 for later use. In some examples, the security infrastructure application circuitry 370 is instantiated by programmable circuitry executing security infrastructure application instructions and/or configured to perform operations such as those represented by the flowchart(s) of FIG. 4.

In some examples, the security infrastructure manager 230 includes means for outputting the generated security infrastructure for use in at least one of a global or local level. For example, the means for outputting may be implemented by security infrastructure application circuitry 370. In some examples, the security infrastructure application circuitry 370 may be instantiated by programmable circuitry such as the example programmable circuitry 712 of FIG. 7. For instance, the security infrastructure application circuitry 370 may be instantiated by the example microprocessor 800 of FIG. 8 executing machine executable instructions such as those implemented by at least block 450 of FIG. 4. In some examples, the security infrastructure application circuitry 370 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security infrastructure application circuitry 370 may be instantiated by any other combination of hardware, software, and/or firmware. For example, the security infrastructure application circuitry 370 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The security infrastructure monitoring circuitry 380 monitors the operation of the security infrastructure. In some examples, the security infrastructure monitoring circuitry 380 is instantiated by programmable circuitry executing security infrastructure monitoring instructions and/or configured to perform operations such as those represented by the flowchart(s) of FIGS. 4 and/or 6.

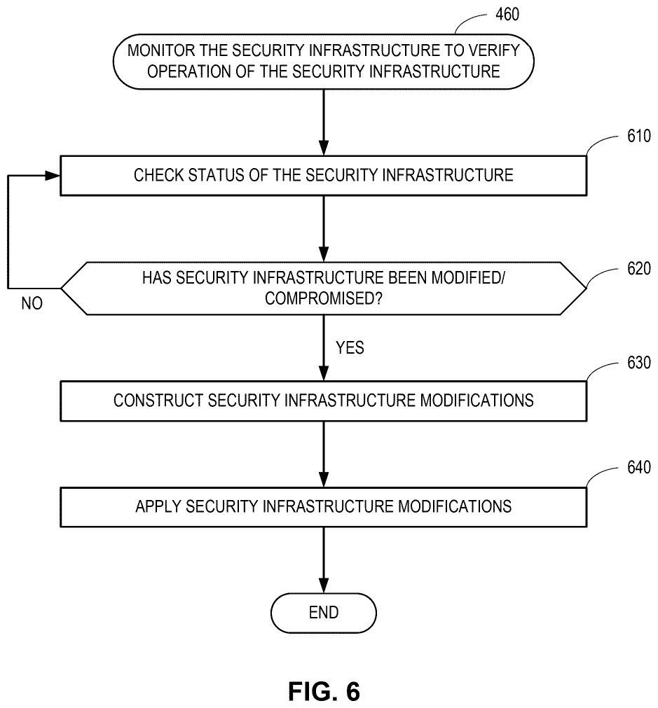

In some examples, the security infrastructure manager 230 includes means for monitoring the security infrastructure during operation. For example, the means for monitoring may be implemented by security infrastructure monitoring circuitry 380. In some examples, the security infrastructure monitoring circuitry 380 may be instantiated by programmable circuitry such as the example programmable circuitry 712 of FIG. 7. For instance, the security infrastructure monitoring circuitry 380 may be instantiated by the example microprocessor 800 of FIG. 8 executing machine executable instructions such as those implemented by at least blocks 460 of FIGS. 4 and 610, 620, 630, and 640 of FIG. 6. In some examples, the security infrastructure monitoring circuitry 380 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the security infrastructure monitoring circuitry 380 may be instantiated by any other combination of hardware, software, and/or firmware. For example, the security infrastructure monitoring circuitry 380 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the security infrastructure manager 230 of FIG. 2 is illustrated in FIG. 3, one or more of the elements, processes, and/or devices illustrated in FIG. 3 may be combined, divided, re-arranged, omitted, eliminated, and/or implemented in any other way. Further, example security instructor circuitry 210, and example global infrastructure identification circuitry 320, example global infrastructure application circuitry 330, example security infrastructure generation circuitry 340, example security provisioning circuitry 350, example security authorization circuitry 360, example security infrastructure application circuitry 370, example security infrastructure monitoring circuitry 380 and/or, more generally, the example security infrastructure manager 230 of FIG. 3, may be implemented by hardware alone or by hardware in combination with software and/or firmware. Thus, for example, any of the example security instructor circuitry 210, and example global infrastructure identification circuitry 320, example global infrastructure application circuitry 330, example security infrastructure generation circuitry 340, example security provisioning circuitry 350, example security authorization circuitry 360, example security infrastructure application circuitry 370, example security infrastructure monitoring circuitry 380, and/or, more generally, the example security infrastructure manager 230, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example security infrastructure manager 230 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the security infrastructure manager 230 of FIG. 3 and/or representative of example operations which may be performed by programmable circuitry to implement and/or instantiate the security infrastructure manager 230 of FIG. 3, are shown in FIGS. 4-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example security infrastructure manager 230 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to generate and monitor a security infrastructure. The example machine-readable instructions and/or the example operations 400 of FIG. 4 begin at block 410, at which the security instructor circuitry 210 retrieves a security infrastructure generation request from the EDS 108 via the event trigger service 110. In some examples, the security infrastructure generation request originates from an end-user requesting to generate the security infrastructure (e.g., from the cloud-based service(s) 102). In some examples, the security infrastructure generation request originates from a determination that an existing security systems needs to be upgraded (e.g., the existing security system is insufficient for a given environment).

Once the security instructor circuitry 210 retrieves a security infrastructure generation request, the global infrastructure identification circuitry 320 detects whether a global infrastructure template exists. (Block 420). In some examples, the existence of a global infrastructure template includes application/environment-specific resources/identifiers that are to be included in the generated security infrastructure. Examples of such resources/identifiers include a count/number of computing devices within the environment, specific security measures needed for the given environment, identified security risks, etc.

Once the global infrastructure identification circuitry 320 detects whether a global infrastructure template exists, the global infrastructure application circuitry 330 classifies parameters (e.g., variables) within the global infrastructure template for environment-specific security generation. (Block 430). In some examples, the classifying the parameters includes allocating computing resources, allocating additional security measures, weighing which security measures are most important (e.g., giving higher weights to transactions/operations that are deemed to be more of a security risk), etc.

Once the global infrastructure application circuitry 330 classifies the parameters, the security infrastructure generation circuitry 340 generates the security infrastructure based on the global infrastructure template and the classified parameters. (Block 440). In some examples, the security infrastructure template is generated based on additional considerations such as computing resources available, an authorization key, etc. The security infrastructure is generated automatically (e.g., without user intervention) based on the global infrastructure template and the classified parameters. Generating the security infrastructure automatically eliminates a need for a user to manually generate a security infrastructure which takes time, requires expertise, and is susceptible to failures due to human error.

Once the security infrastructure generation circuitry 340 generates the security infrastructure, the security infrastructure application circuitry 370 outputs the generated security infrastructure for use. (Block 450). In some examples, the generated security infrastructure is to be applied at a global level (e.g., affecting all computing devices within an environment). In other examples, the generated security infrastructure is to be applied at an individual compute device level or within a subset of the global environment. In either case, outputting the generated security infrastructure enables the ability to apply the security infrastructure as desired.

Once the security infrastructure application circuitry 370 outputs the generated security infrastructure, the security infrastructure monitoring circuitry 380 monitors the operation of the security infrastructure. (Block 460). In some examples, the monitoring of the security infrastructure includes determining whether the security infrastructure needs to be updated (e.g., regenerated) or whether a security risk has been detected. In some examples, the monitoring of the security infrastructure is continuous (e.g., on-going during operation). In other examples, the monitoring of the security infrastructure is performed at a defined interval (e.g., upon completion/request of an operation, upon startup, every day, etc.).

FIG. 5 is a flowchart representative of example machine readable instructions and/or example operations that may be executed, instantiated, and/or performed by programmable circuitry to implement the security infrastructure generation circuitry 340 of FIG. 3. The example machine-readable instructions and/or the example operations of FIG. 5 begin at block 510, at which the security provisioning circuitry 350 generates a provisioning request. In some examples, the provisioning request is sent/communicated to a computing device and/or an environment to provision computing resources to be able to generate and run the security infrastructure.

Once the security provisioning circuitry 350 generates a provisioning request, the security provisioning circuitry 350 provisions the security infrastructure based on the provisioning request. (Block 520). In some examples, the provisioning of the security infrastructure includes allocating/reserving computing resources to install and/or run the security infrastructure on the compute device/environment. In some examples, the provisioning of the security infrastructure includes communicating a message to the compute device/environment to provision the computing resources.

Once the security provisioning circuitry 350 provisions the security infrastructure, the security authorization circuitry 360 identifies whether a security generation authorization exists. (Block 530). In some examples, the security infrastructure is only able to generate when a security generation authorization is identified (e.g., to prevent malicious manipulation of an existing security infrastructure). In such an example, the security generation authorization is retrieved by the security instructor circuitry 210 from the EDS 108 via the event trigger service 110. In other examples, the security generation authorization is embedded/included with the security infrastructure generation request.

Once the security authorization circuitry 360 identifies the security generation authorization or determines that no security authorization is required, the security infrastructure generation circuitry 340 generates the security infrastructure. (Block 540). As disclosed above, the generation of the security infrastructure can be based on the provisioning of the security infrastructure, the global infrastructure template, the classified parameters, and the identified security generation authorization. It is conceivable that additional, fewer, or a different combination of measures may be taken to generate the security infrastructure.

FIG. 6 is a flowchart representative of example machine readable instructions and/or example operations that may be executed, instantiated, and/or performed by programmable circuitry to implement the security infrastructure monitoring circuitry 380 of FIG. 3. The example machine-readable instructions and/or the example operations of FIG. 6 begin at block 610, at which the security infrastructure monitoring circuitry 380 checks a status of the operation of the security infrastructure. In some examples, the status includes amount of computing resources used, whether any security risks have been identified, whether the security infrastructure has been regenerated, etc.

Once the security infrastructure monitoring circuitry 380 checks the status of the security infrastructure, the security infrastructure monitoring circuitry 380 determines whether the security infrastructure has been modified and/or compromised. (Block 620). In some examples, the security infrastructure being modified includes a regeneration of the security infrastructure. In other examples, the security infrastructure is manually modified by a user of the environment/compute device running the security infrastructure. In such an example, the security infrastructure may not operate properly when manually modified and may require a regeneration of the security infrastructure to eliminate any potential flaws. In some examples, the manual modification of the security infrastructure also compromises the security infrastructure, resulting in opening for cyber-attacks. In some examples, the generated security infrastructure failed to capture a potential security risk and the security infrastructure monitoring circuitry 380 has identified a new risk requiring a regeneration of the security infrastructure.

When the security infrastructure monitoring circuitry 380 determines that the security infrastructure has not been modified and/or compromised (e.g., block 620 returns a result of NO), the security infrastructure monitoring circuitry 380 re-checks the status of the security infrastructure at block 610. In some examples, the monitoring of the security infrastructure is continuous (e.g., on-going during operation). In other examples, the monitoring of the security infrastructure is performed at a defined interval (e.g., upon completion/request of an operation, upon startup, every day, etc.).

When the security infrastructure monitoring circuitry 380 determines that the security infrastructure has been modified and/or compromised requiring intervention (e.g., block 620 returns a result of YES), the security infrastructure monitoring circuitry 380 constructs security infrastructure modifications to apply to the security infrastructure. (Block 630). In some examples, the security infrastructure modifications constructed include modifications that can be applied to the existing security infrastructure (e.g., eliminating read/write access under certain conditions, restoring a erroneously deleted file, etc.). In other examples, the security infrastructure modifications include a complete regeneration of the security infrastructure.

Once the security infrastructure monitoring circuitry 380 constructs the security infrastructure modifications, the security infrastructure monitoring circuitry 380 applies the security infrastructure modifications to the security infrastructure. (Block 640). In some examples, the security infrastructure modifications are applied directly to the existing security infrastructure (e.g., applying the changes and re-compiling/applying the security infrastructure). In examples where the security infrastructure is to be regenerated, the security infrastructure monitoring circuitry 380 instructs the security infrastructure generation circuitry 340 to regenerate the security infrastructure. Such an instruction may include a security generation authorization and/or an updated security infrastructure template for which the security infrastructure generation circuitry 340 bases the generation of the security infrastructure on.

FIG. 7 is a block diagram of an example programmable circuitry platform 700 structured to execute and/or instantiate the example machine-readable instructions and/or the example operations of FIGS. 4-6 to implement the security infrastructure manager 230 of FIG. 3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements security instructor circuitry 210, global infrastructure identification circuitry 320, global infrastructure application circuitry 330, security infrastructure generation circuitry 340, security provisioning circuitry 350, security authorization circuitry 360, security infrastructure application circuitry 370, and security infrastructure monitoring circuitry 380.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.) and/or any other suitable output device. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 2 as logic circuits to perform operations corresponding to those machine readable instructions. In some such examples, the circuitry of FIG. 3 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIG. 3 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 3 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

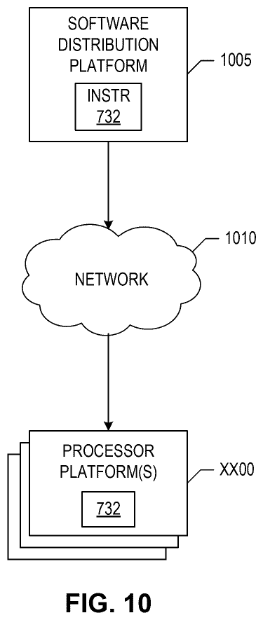

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4-6, may be downloaded to the example programmable circuitry platform 700, which is to execute the machine readable instructions 732 to implement the security infrastructure manager 230. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that generates a security infrastructure. Disclosed systems, apparatus, articles of manufacture, and methods improve the efficiency of using a computing device by eliminating the need for user-operated manual generation of a security infrastructure that is prone to errors and inconsistencies. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to generate a security infrastructure for a compute device, the apparatus comprising:
interface circuitry;
machine readable instructions; and
programmable circuitry to at least one of instantiate or execute the machine readable instructions to:
provision the security infrastructure based on a security infrastructure generation request;
detect a global infrastructure template based on the security infrastructure generation request; and
generate the security infrastructure based on the provisioned security infrastructure, the global infrastructure template, and an identified security infrastructure generation authorization, the security infrastructure generation authorization to indicate whether the generation of the security infrastructure is permitted.

2. The apparatus of claim 1, wherein the programmable circuitry is to generate a provisioning request, the security infrastructure to be provisioned based on the security infrastructure generation request and the provisioning request.

3. The apparatus of claim 1, wherein the programmable circuitry is to classify parameters for environment specific security infrastructure generation.

4. The apparatus of claim 1, wherein the programmable circuitry is to output the generated security infrastructure for use in at least one of a global level or a local level.

5. The apparatus of claim 1, wherein the programmable circuitry is to monitor the security infrastructure during operation.

6. The apparatus of claim 5, wherein the programmable circuitry is to:
check a status of the security infrastructure; and
determine whether the security infrastructure has been at least one of modified or compromised.

7. The apparatus of claim 6, wherein the programmable circuitry is to construct security infrastructure modifications based on a determination that the security infrastructure has been at least one of modified or compromised.

8. The apparatus of claim 7, wherein the programmable circuitry is to apply the constructed security infrastructure modifications to the security infrastructure.

9. A non-transitory machine readable storage medium comprising instructions to cause programmable circuitry to at least:
provision security infrastructure based on a security infrastructure generation request;
detect a global infrastructure template based on the security infrastructure generation request; and
generate the security infrastructure based on the provisioned security infrastructure, the global infrastructure template, and an identified security infrastructure generation authorization, the security infrastructure generation authorization to indicate whether the generation of the security infrastructure is permitted.

10. The non-transitory machine readable storage medium of claim 9, wherein the instructions cause the programmable circuitry to generate a provisioning request, the security infrastructure to be provisioned based on the security infrastructure generation request and the provisioning request.

11. The non-transitory machine readable storage medium of claim 9, wherein the instructions cause the programmable circuitry to classify parameters for environment specific security infrastructure generation.

12. The non-transitory machine readable storage medium of claim 9, wherein the instructions cause the programmable circuitry to output the generated security infrastructure for use in at least one of a global level or a local level.

13. The non-transitory machine readable storage medium of claim 9, wherein the instructions cause the programmable circuitry to monitor the security infrastructure during operation.

14. The non-transitory machine readable storage medium of claim 13, wherein the instructions cause the programmable circuitry to:
check a status of the security infrastructure; and
determine whether the security infrastructure has been at least one of modified or compromised.

15. The non-transitory machine readable storage medium of claim 14, wherein the instructions cause the programmable circuitry to construct security infrastructure modifications based on a determination that the security infrastructure has been at least one of modified or compromised.

16. The non-transitory machine readable storage medium of claim 15, wherein the instructions cause the programmable circuitry to apply the constructed security infrastructure modifications to the security infrastructure.

17. A method for generating a security infrastructure, the method comprising:
provisioning the security infrastructure based on a security infrastructure generation request;
detecting a global infrastructure template based on the security infrastructure generation request; and
generating the security infrastructure based on the provisioned security infrastructure, the global infrastructure template, and an identified security infrastructure generation authorization, the security infrastructure generation authorization to indicate whether the generation of the security infrastructure is permitted.

18. The method of claim 17, further including generating a provisioning request, the security infrastructure to be provisioned based on the security infrastructure generation request and the provisioning request.

19. The method of claim 17, further including classifying parameters for environment specific security infrastructure generation.

20. The method of claim 17, further including outputting the generated security infrastructure for use in at least one of a global level or a local level.

21. The method of claim 17, further including monitoring the security infrastructure during operation.

22. The method of claim 21, further including:
checking a status of the security infrastructure; and
determining whether the security infrastructure has been at least one of modified or compromised.

23. The method of claim 22, further including constructing security infrastructure modifications based on a determination that the security infrastructure has been at least one of modified or compromised.

24. The method of claim 23, further including applying the constructed security infrastructure modifications to the security infrastructure.
